(19) United States
(12) Patent Application Publication
(10) Pub. No.: US 2002/0049087 A1
(43) Pub. Date: Apr. 25, 2002

(54) Information processing apparatus, information processing method, and recording medium

(76) Inventors: Teruyuki Ushiro, Chiba (JP); Hideki Oyaizu, Tokyo (JP); Yoshiaki Iwai, Tokyo (JP); Weiguo Wu, Tokyo (JP); Masaaki Oka, Tokyo (JP)

Correspondence Address: BELL, BOYD & LLOYD, LLC, P. O. BOX 1135, CHICAGO, IL, 60690-1135, US

(21) Appl. No.: 09/948,829

(22) Filed: Sep. 7, 2001

(30) Foreign Application Priority Data
Sep. 7, 2000 (JP) P2000-271884

(51) Int. Cl. A63F 13/00

(52) U.S. Cl. 463/42

(57) ABSTRACT

An information processing apparatus is provided. The information processing apparatus is connected to a terminal which executes a program for a number of different games, through a network. The information processing apparatus includes a storage device for storing information on a character that can appear in the different games in the terminal. A transmitter is provided to transmit the information on the character to the terminal in response to a request from the terminal.

### BACKGROUND OF THE INVENTION

The present invention relates to an information processing apparatus, an information processing method, and a recording medium. More particularly, the present invention relates to an information processing apparatus, an information processing method, and a recording medium, which permit a given character to be used in a plurality of different computer games.

Among computer games (hereinafter simply “games”), there are games in which a characteristic character appears. In general, however, a given character can only be used in a particular game, that is, a single game, or the same series of games. Typically, a character cannot be used in other unrelated games.

In addition, games may be devised where characters appearing in a game change during the course of the game, acquiring a new shape, gaining or losing power (for example, in the case of a fighting game, power for employing a given skill), acquiring or losing items (for example, clothes that can be furnished by the character), or the like. In this manner, because the character changes (grows), a user can enjoy the change (growth). The changing characteristics of the character help the user to sympathize with the character.

However, in general, when play (for example, one play) is completed, the altered characteristics of the character, such as the shape, the power, and the like, which have been acquired by the character, are reset. Because of this, when play is re-started, the character begins the next play in its initial state. Therefore, the user cannot enjoy the character's growth and development continuously from play to play.

For this reason, games have been developed wherein by recording a shape, power, and the like, of a character which have been acquired during play on a recording medium, the altered characteristics can be applied to the character and will appear in the next play, or can be applied to the character when used in the same series of games. However, even in such a game, the character itself cannot be used in the other unrelated games (games that belong to different series). Therefore, the shape, the power, and the like, which have been acquired, cannot be applied to the other games.

### SUMMARY OF THE INVENTION

In light of the preceding background, an object of the present invention is to provide an information processing apparatus, an information processing method and a recording medium which enable a user to use a character which retains various variable characteristics such as shape, power, and the like, which may be acquired by the user during the course of play, in a number of different games.

To achieve the above object, according to a first aspect of the present invention there is provided an information processing apparatus connected to a terminal, which executes a program for a number of different games, through a network, including a storage device for storing information on a character that can appear in the different games in the terminal; and a transmitter for transmitting the information on the character to the terminal in response to a request from the terminal.

According to a second aspect of the present invention, there is provided an information processing apparatus connected to a terminal, which executes a program for a number of different games, through a network, including a storage device for storing information on a character that can appear in the different games in the terminal; a transmitter for transmitting the information on the character to the terminal in response to a request from the terminal; a receiver for receiving the information on the character transmitted from the terminal; and an editor for editing the information on the character, which is stored in the storage device, according to the information on the character received by the receiver.

According to a third aspect of the present invention, there is provided an information processing apparatus connected to a terminal, which executes a program for a number of different games, through a network, including a storage device for storing information on a character that can appear in the different games in the terminal; a transmitter for transmitting the information on the character to the terminal in response to a request from the terminal; and a timer for obtaining utilization time of the character, which has been used in the game in the terminal, from the terminal; wherein the storage device stores the utilization time, which has been obtained by the timer, for each game.

According to a fourth aspect of the present invention, there is provided an information processing method of an information processing apparatus connected to a terminal, which executes a program for a number of games, through a network, the information processing method including a holding step for holding information on a character that can appear in the different games in the terminal; and a transmitting step for transmitting the information on the character to the terminal in response to a request from the terminal.

According to a fifth aspect of the present invention, there is provided an information processing method of an information processing apparatus connected to a terminal, which executes a program for a number of different games, through a network, the information processing method including a holding step for holding information on a character that can appear in the different games in the terminal; a transmitting step for transmitting the information on the character to the terminal in response to a request from the terminal; a receiving step for receiving the information on the character transmitted from the terminal; and an updating step for updating the held information on the character according to the information on the character received in the receiving step.

According to a sixth aspect of the present invention, there is provided an information processing method of an information processing apparatus connected to a terminal, which executes a program for a number of different games, through a network, the information processing method including a holding step for holding information on a character that can appear in the different games in the terminal; a transmitting step for transmitting the information on the character to the terminal in response to a request from the terminal; and an obtaining step for obtaining utilization time of the character, which has been used in the game in the terminal, from the terminal; and a utilization time holding step for holding the utilization time, which has been obtained in the obtaining step, for each game.

According to a seventh aspect of the present invention, there is provided a recording medium, on which a computer-readable program is recorded, wherein the computer-readable program is a program of an information processing apparatus connected to a terminal, which executes a program for a number of different games, through a network, the computer-readable program including a holding step for holding information on a character that can appear in the different games in the terminal; and a transmitting step for transmitting the information on the character to the terminal in response to a request from the terminal.

According to an eighth aspect of the present invention, there is provided a recording medium, on which a computer-readable program is recorded, wherein the computer-readable program is a program of an information processing apparatus connected to a terminal, which executes a program for a number of different games, through a network, the computer-readable program including a holding step for holding information on a character that can appear in the different games in the terminal; a transmitting step for transmitting the information on the character to the terminal in response to a request from the terminal; a receiving step for receiving the information on the character transmitted from the terminal; and an updating step for updating the held information on the character according to the information on the character received in the receiving step.

According to a ninth aspect of the present invention, there is provided a recording medium, on which a computer-readable program is recorded, wherein the computer-readable program is a program of an information processing apparatus connected to a terminal, which executes a program for a number of different games, through a network, the computer-readable program including a holding step for holding information on a character that can appear in the different games in the terminal; a transmitting step for transmitting the information on the character to the terminal in response to a request from the terminal; an obtaining step for obtaining utilization time of the character, which has been used in the game in the terminal, from the terminal; and a utilization time holding step for holding the utilization time, which has been obtained in the obtaining step, for each game.

The above and other features and advantages of the present invention will become apparent from the following description which will be given with reference to the illustrative accompanying drawings.

Additional features and advantages of the present invention are described in, and will be apparent from, the following Detailed Description of the Invention and the figures.

### BRIEF DESCRIPTION OF THE FIGURES

FIG. 1 is a diagram of a game character system to which the present invention is applied;

FIG. 2 is a block diagram of a game machine shown in FIG. 1;

FIG. 3 is a block diagram of a character server shown in FIG. 1;

FIG. 4 is a diagram illustrating stored content of a storing unit of a character server;

FIG. 5 is a diagram illustrating “three-dimensional information”;

FIG. 6 is a diagram illustrating “attributes”;

FIG. 7 is a diagram illustrating “item furnishing information”;

FIG. 8 is a diagram illustrating “item”;

FIG. 9 is a diagram illustrating “social information”;

FIG. 10 is a diagram illustrating “history information”;

FIG. 11 is a diagram illustrating other stored contents of a storing unit of a character server;

FIG. 12 is a flowchart illustrating a character information downloading process;

FIG. 13 is a flowchart illustrating a security information input process;

FIG. 14 is a diagram illustrating an example of an input screen for entering a user id and password;

FIG. 15 is a flowchart illustrating a user authentication process;

FIG. 16 is a diagram illustrating the display of an example character list;

FIG. 17 is a flowchart illustrating an item furnishment changing process;

FIG. 18 is a flowchart illustrating a character information uploading process;

FIG. 19 is a diagram illustrating another example of a game character system, to which the present invention is applied; and

FIG. 20 is an example block diagram of the configuration of a computer according to the present information.

### DETAILED DESCRIPTION OF THE INVENTION

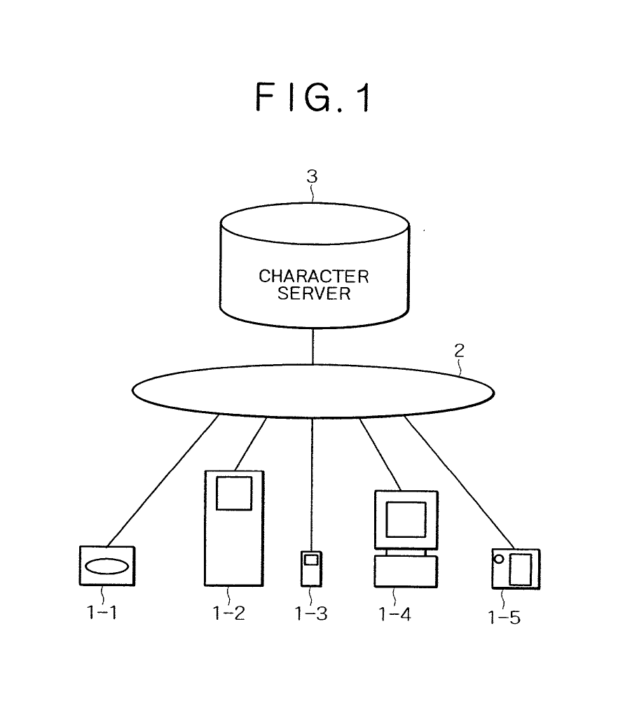

FIG. 1 shows an example of how a game character system, to which the present invention is applied. A home game machine 1-1, an arcade game machine 1-2, a portable game machine 1-3, a network computer 1-4, and a network portable terminal 1-5 are each connected to a character server 3 through a network 2. The game machines 1-1, 1-2 and 1-3 are used by the various users registered in the system. Hereafter the game machines 1-1, 1-2 and 1-3 will be referred to collectively as game machine 1 unless it is necessary to distinguish them individually.

The game machine 1 downloads information relating to a character (hereinafter character information). The character information is a possession of a user of the game machine 1 and is stored in the character server 3. The game machine downloads the character information from the character server 3 through the network 2. A plurality of games may be executed in the game machine 1, and the user can use a character based on the downloaded character information in each of the various games.

In addition, the game machine 1 may also upload character information from game machine 1 to be stored on character server 3. Thus, a character which has grown up during the course of the user playing a game, or character information which has been edited to alter a character, can be saved to server 3 through the network 2. By downloading the uploaded character, the next time the user plays a game on game machine 1 the character information which had been previously uploaded to the character server 3 can be downloaded back to the game machine 1 so that the user can use the grown-up or altered character in the plurality of games executed in the game machine 1.

The character server 3 stores character information for each user. The character server 3 supplies the character information, which is stored for the user, in response to a request from the game machine 1. In addition, the character server 3 also updates the character information, which is stored for the user, according to the character information supplied from the game machine 1.

It should be noted that, in the case of this example, a character may take the form of a game player (user) himself/herself, or a pet character. When the character represents the player himself/herself the character takes the place of the player in the game. A pet character is a character such as, for example, a monster, which accompanies the character as the player himself/herself participates in a role-playing game, or the character may represent a horse that appears on a horse racing game.

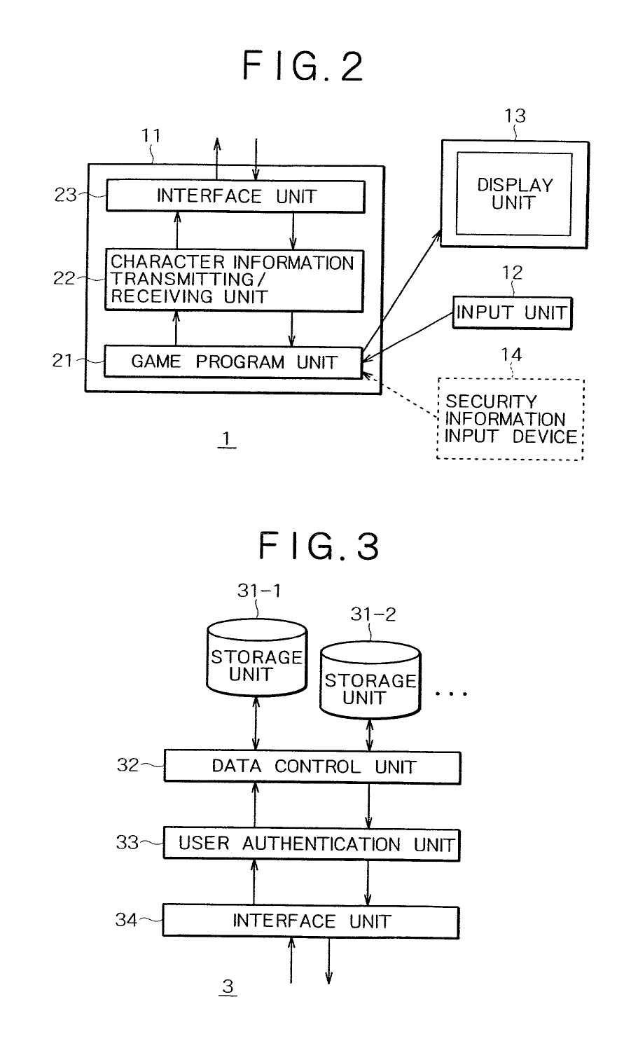

FIG. 2 illustrates an example of the configuration of the game machine 1. The game machine 1 includes, for example, a main body 11, an input unit 12, and a display unit 13. The main body 11 executes a program for a game, and displays video in the display unit 13 which corresponds to operations input by the user via input unit 12.

Communication with the character server 3 is performed according to security information input from the main body 11 or the input unit 12. Alternatively, the security information can also be input by a dedicated security information input device 14 (shown as a dotted-line frame in FIG. 2) instead of the input unit 12.

The main body 11 comprises a game program unit 21, a character information transmitting/receiving unit 22, and an interface unit 23.

The game program unit 21 executes the program for the game and displays video in the display unit 13 corresponding to input operations from the input unit 12. A character, which is based on character information supplied from a character data transmitting/receiving unit 22 (i.e., character information downloaded from the character server 3), can appear in the video.

In addition, the game program unit 21 can also output the character information of a character which has grown or has otherwise changed during the course of playing a game, or which has been edited, to the character information transmitting/receiving unit 22.

The character information transmitting/receiving unit 22 controls the interface unit 23 to receive the character information transmitted from the character server 3, and to supply the received character information to the game program unit 21. The character information transmitting/receiving unit 22 controls the interface unit 23 to transmit the character information, which has been supplied from the game program unit 21, to the character server 3.

The interface unit 23 is connected to the network 2, and communicates with the character server 3.

FIG. 3 illustrates the configuration of an example of the character server 3. The character server 3 includes a number of storage units 31 (31-1, 31-2, . . . ), a data control unit 32, a user authentication unit 33, and an interface unit 34.

Each of the storage units 31 stores character information, and the like, and corresponds to each user registered in the game character system.

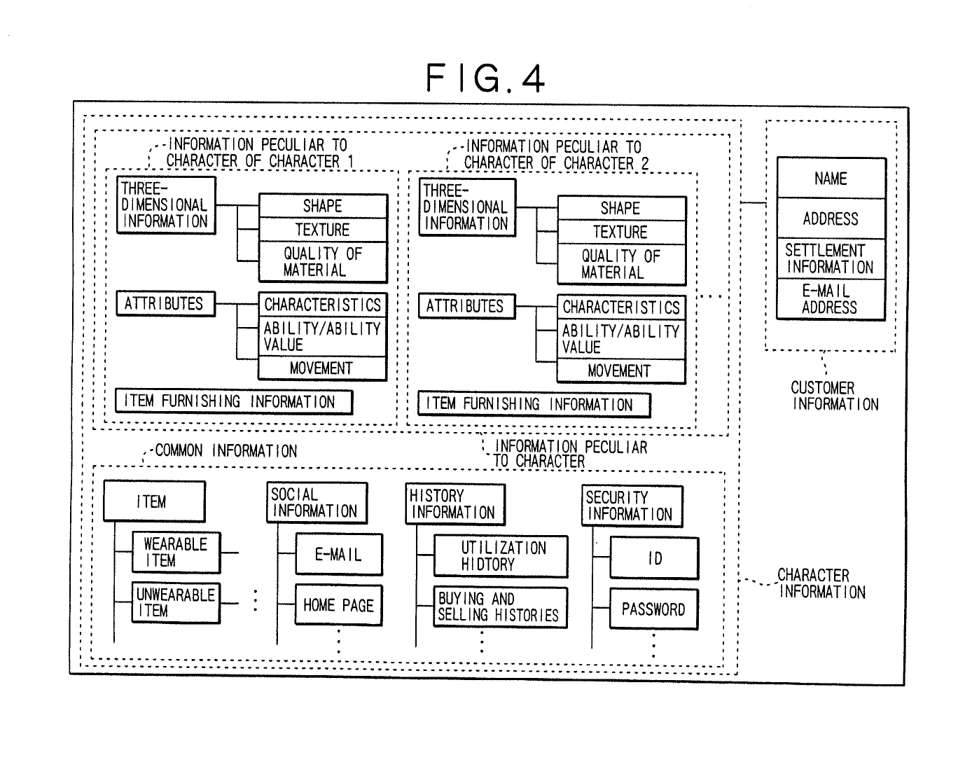

FIG. 4 illustrates stored content of the storage unit 31. Character information and customer information are stored in the storage unit 31. The customer information includes a user's name, an address, settlement information, and an e-mail address. In the case of this example, the character information includes information peculiar to each character possessed by the user (hereinafter referred to as character specific information), as well as information that applies to all characters possessed by the user in common (hereinafter referred to as common information).

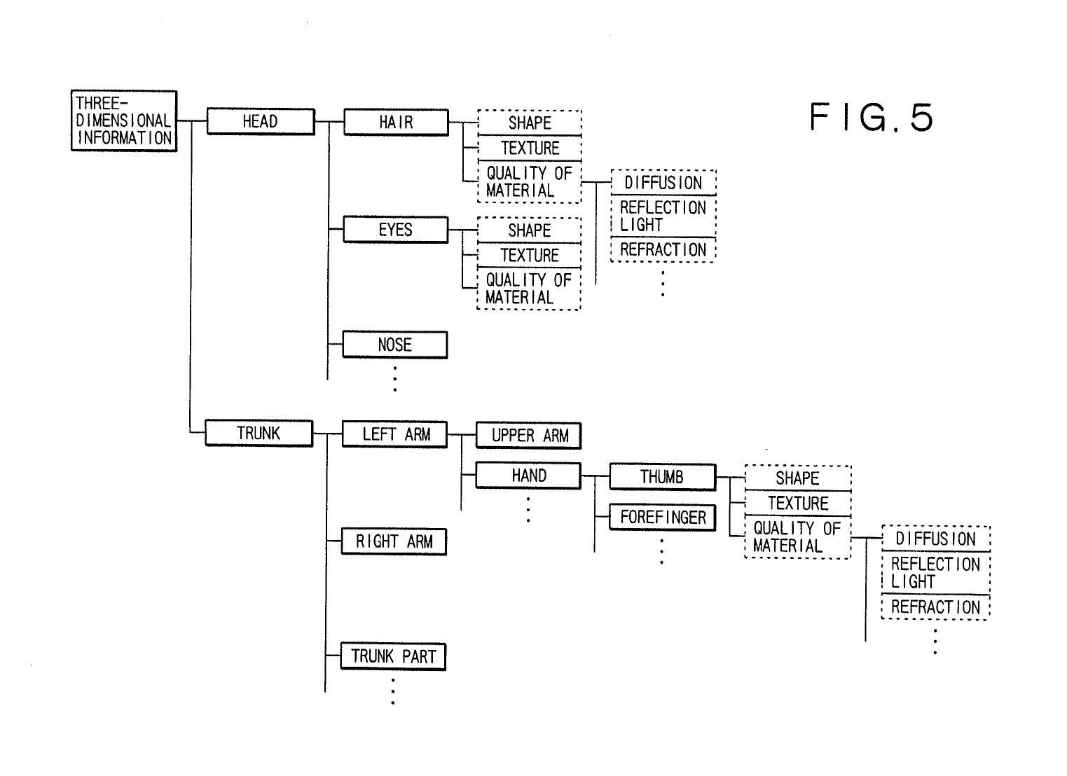

The character specific information includes “three-dimensional information”, “attributes”, and “item furnishing information”. The “three-dimensional information” is used to identify appearance of a character. As shown in FIG. 5, for example, the “three-dimensional information” includes a shape, texture, and quality of material, which relate to each part of a character's body. The quality of material includes data that represents diffusion, reflection light, or refraction.

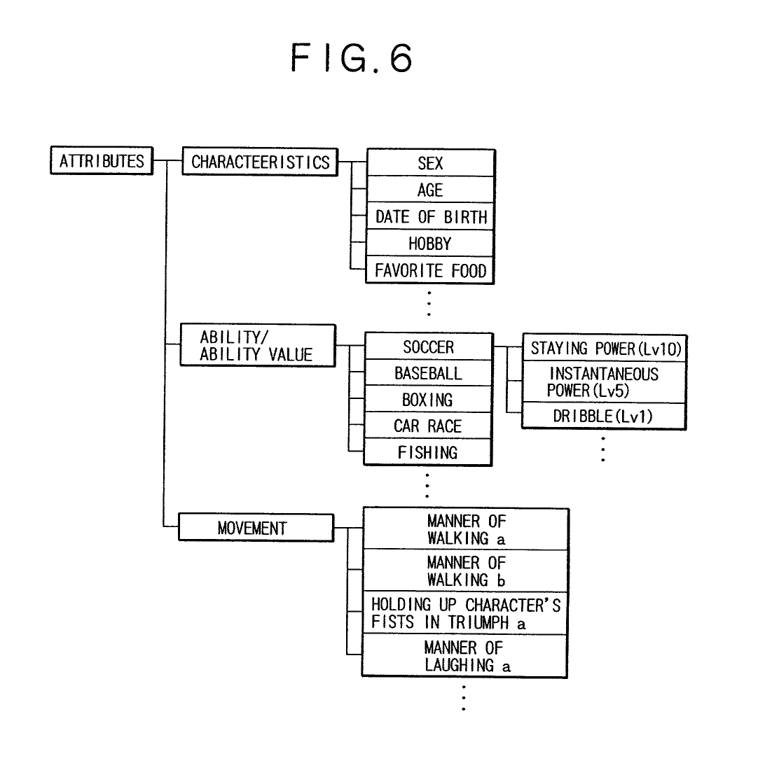

As shown in FIG. 6, for example, the “attributes” include data that is used to identify characteristics, ability/ability value, and movement. The characteristics include data that represent the character's sex, age, date of birth, hobby, favorite food, and the like.

The ability/ability value includes data that represent the character's ability to play, for example, soccer, baseball, boxing, car racing, fishing, and the like. In the example shown in FIG. 6, the character's power to play soccer is as follows: staying power is level 10; instantaneous power is level 5; and dribble power is level 1.

Moreover, in this manner, if registration/power value is stored as character specific information, a given level of power to play boxing (character information) is acquired when the character appears in the boxing game for example. Because of this acquired power, when the character appears in, for example, a fighting game in which different kinds of combative sports are engaged in, the character can make full use of the power acquired in the boxing game. In other words, the character can use a boxing skill.

The movement attribute includes data that identifies character movements such as a character's manner of walking, holding up the character's fists in triumph, and a manner of laughing. In the example shown in FIG. 6, for example, the character has two manners of walking, a manner of walking a, and a manner of walking b.

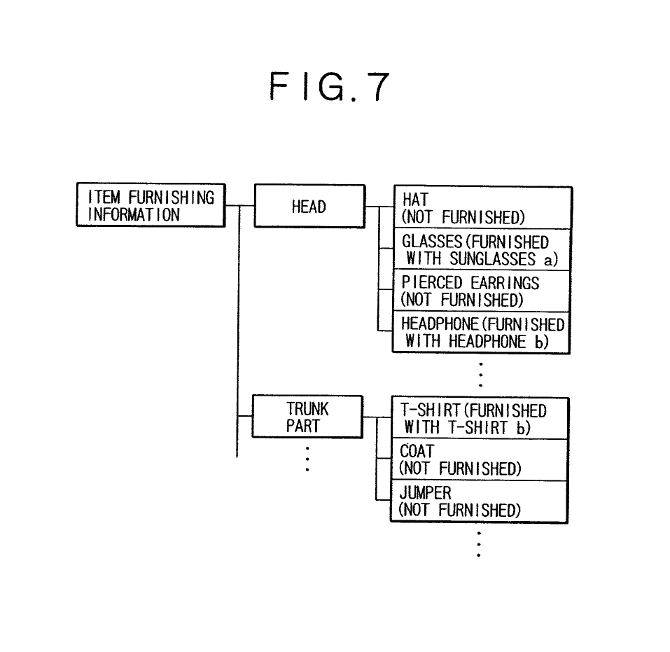

FIG. 7 shows an example of the “item furnishing information.” In this example the “item furnishing information” includes data representing items which can be furnished to the character on each part of the character's body, and its furnishing status.

According to the example shown in FIG. 7, the character's head is furnished with sunglasses a and headphones b. Neither a hat nor pierced earrings are furnished. In addition, the character is furnished with a T-shirt b on its trunk while neither a coat nor a jumper are furnished.

For example, furnishing the character with a T-shirt having an emblem of the game (for example, the T-shirt b), which may be acquired by clearing the racing game up to the last, enables the character furnished with the T-shirt to appear in other games. As a result, for example, when there is an audience watching an arcade game, etc., or when playing a game with a friend, the specially made T-shirt can form a topic of conversation, which permits the players to enjoy the game on another level apart from the competition.

Returning to FIG. 4, the common information includes “item”, “social information”, and “history information”, and “security information”.

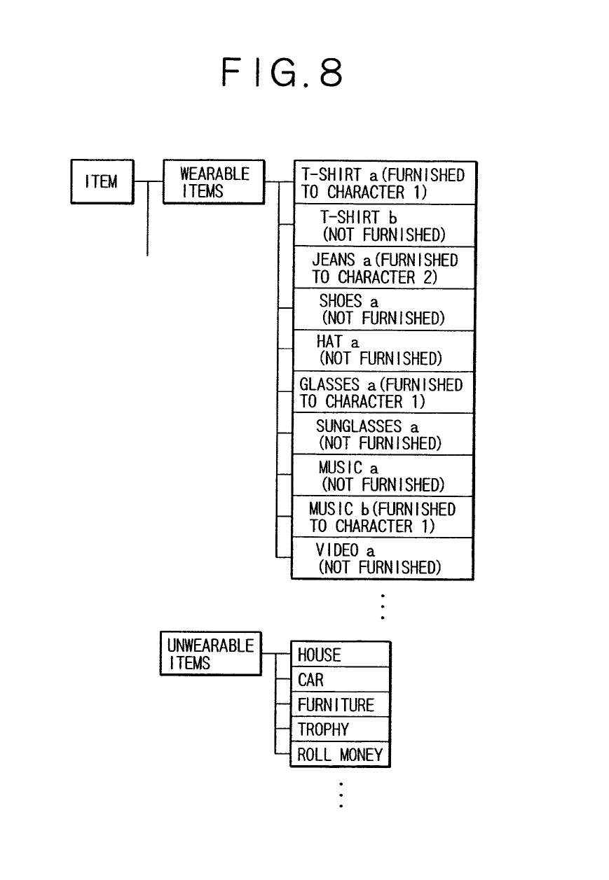

As shown in FIG. 8, the “item” includes items grouped into wearable items and unwearable items, which can be furnished to all of the characters possessed by the user, and data indicating whether characters are presently furnished with the item, or are not presently furnished with the item.

In the case of the example in FIG. 8, wearable items include a T-shirt a, a T-shirt b, jeans a, shoes a, a hat a, glasses a, sunglasses a, music a, music b, and video a. Among the wearable items, the T-shirt a is furnished to a character 1, the jeans a are furnished to a character 2, the glasses a are furnished to the character 1, and the music b is furnished to the character 1. On the other hand, the T-shirt b, the shoes a, the hat a, the sunglasses a, the music a, and the video a are not furnished to any character.

Furnishing the character with music and video permits the music to be played, and permits the video to be displayed, when the furnished character appears.

In the example shown in FIG. 8, the unwearable items include a house, a car, furniture, a trophy, and roll money. For example, if the character is furnished with the roll money, the character can obtain a given thing by spending the roll money in a plurality of games.

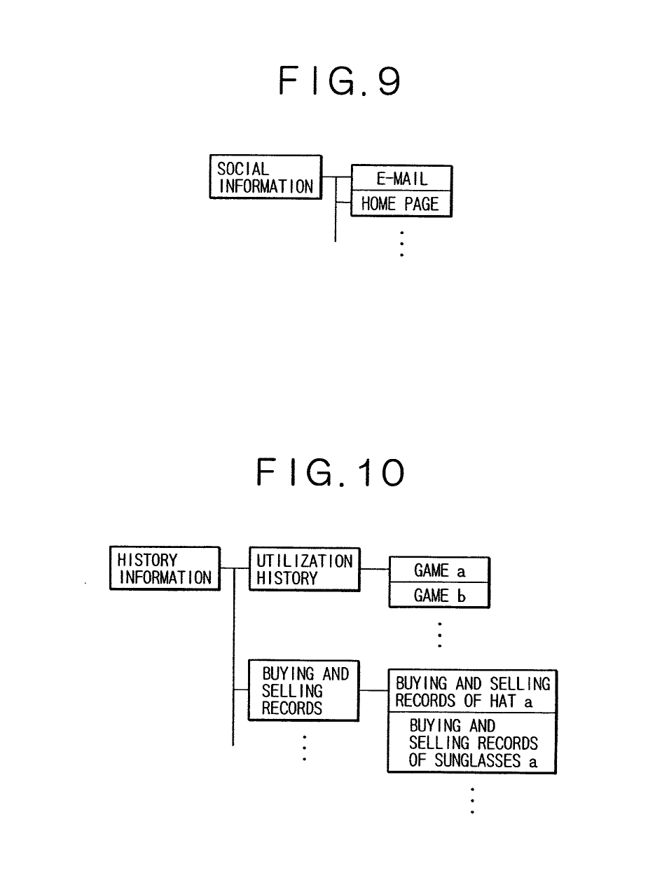

As shown in FIG. 9, for example, the “social information” includes socially utilized information such as an e-mail address and a URL of a home page.

As shown in FIG. 10, for example, the “history information” includes the following: utilization time of game; utilization history such as a time period over which a character appears for each game; and buying and selling histories of items. For example, it is possible to control the character so that the character gets older according to the utilization history.

In the example in FIG. 10, the “history information” includes utilization histories of the game a and the game b, and buying and selling records of the hat a and the sunglasses a.

The “security information” includes an id and a password, which are given to the user.

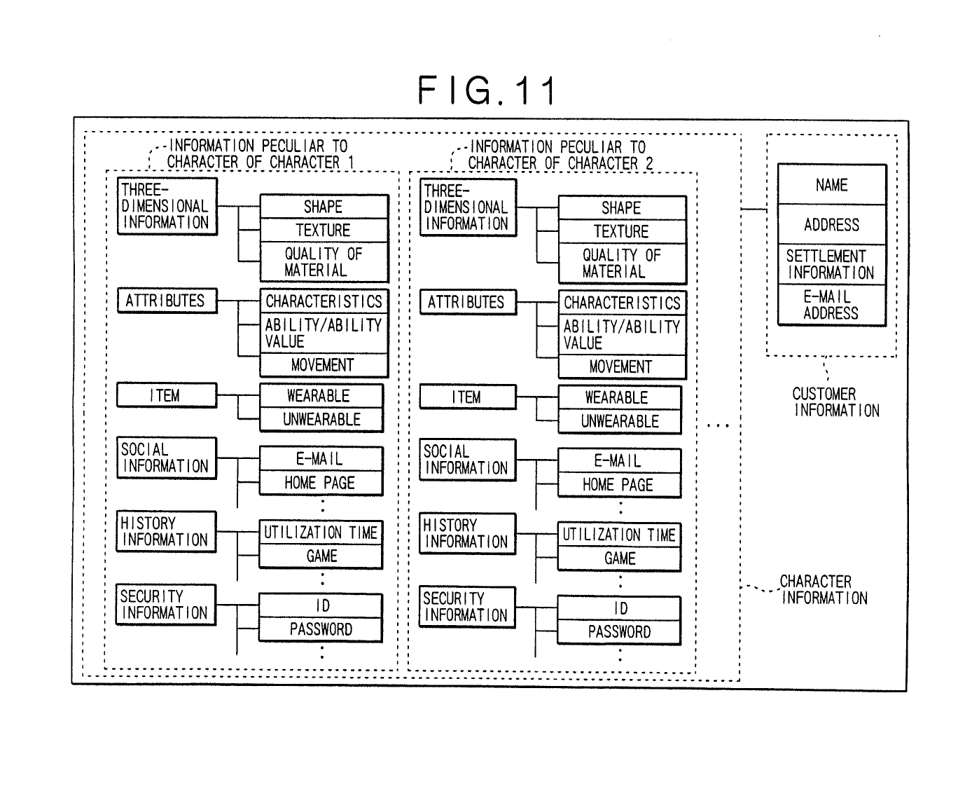

In the example of FIG. 4, the character information includes character specific information, and common information. Various kinds of information such as the common information are provided for each user. However, as shown in FIG. 11, for example, the various kinds of information that form the common information can be provided for each character. To be more specific, in this case, the various kinds of information forming the common information is included in the character specific information.

In the example in FIG. 4, for example, even if an item is bought or sold for a plurality of characters, its history is recorded in the “history information” as common information. Therefore, the user can easily manage the buying and selling of the item. On the other hand, in the case of the example of FIG. 11, the “history information” is recorded as character specific information for each character. Therefore, the buying and selling histories will be distributed among the characters, which causes the buying and selling management to become complex. In other words, if the user has many characters, storing character information is more convenient when stored as shown in the example in FIG. 4.

However, in the example in FIG. 11, each character has “item”, “social information”, “history information”, and “security information” as if the character were a person. This helps the user sympathize with the character. For example, if the character itself has an e-mail address stored in the “social information”, the character can receive e-mail directly from a player of other games.

In the example of FIG. 4, because “item” is assumed to be common information, in other words, because “item” is common to all characters possessed by a user, “item furnishing information” is stored as character specific information. However, in the case of the example shown in FIG. 11, because “item” is managed for each character, “item furnishing information” does not exist.

In this connection, information stored in the storage unit 31, which was described with reference to FIGS. 4 through 11, is provided with an id for each item. Therefore, information can be identified by a character id and an item id.

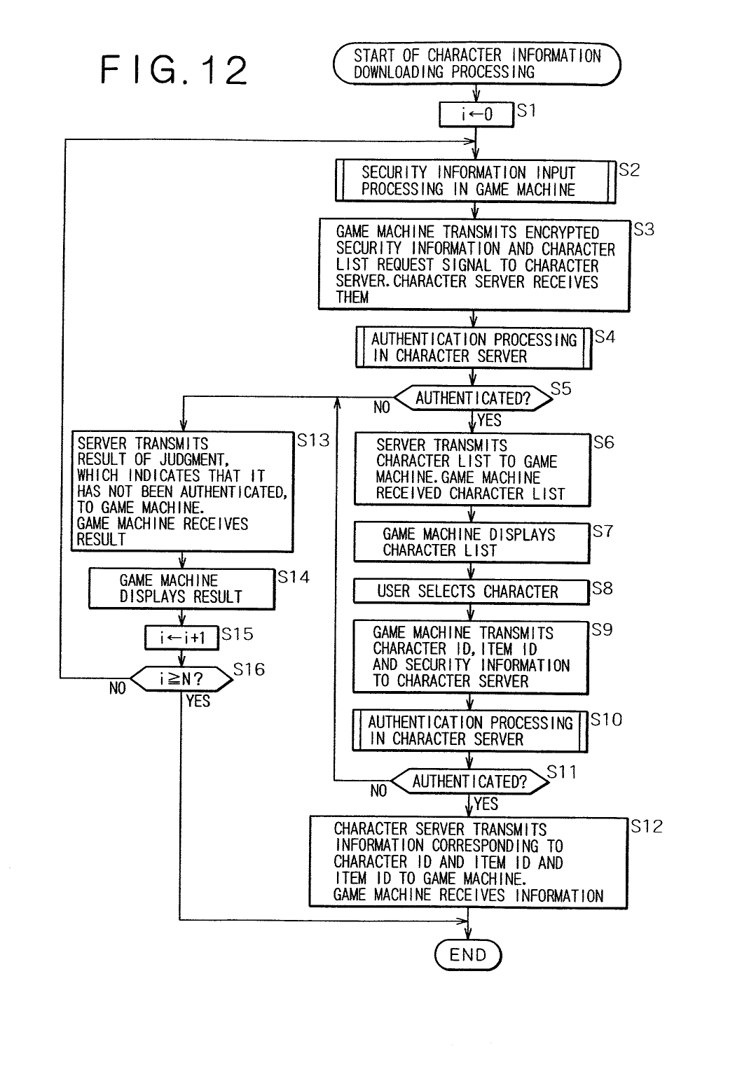

Next, processing procedures used when character information is downloaded from the character server 3 will be described with reference to the flowchart shown in FIG. 12. It is to be noted that the processing is usually performed when a game is started in the game machine 1.

In a step S1, a game program unit 21 of the game machine 1 initializes a counter i so that the counter i has value 0.

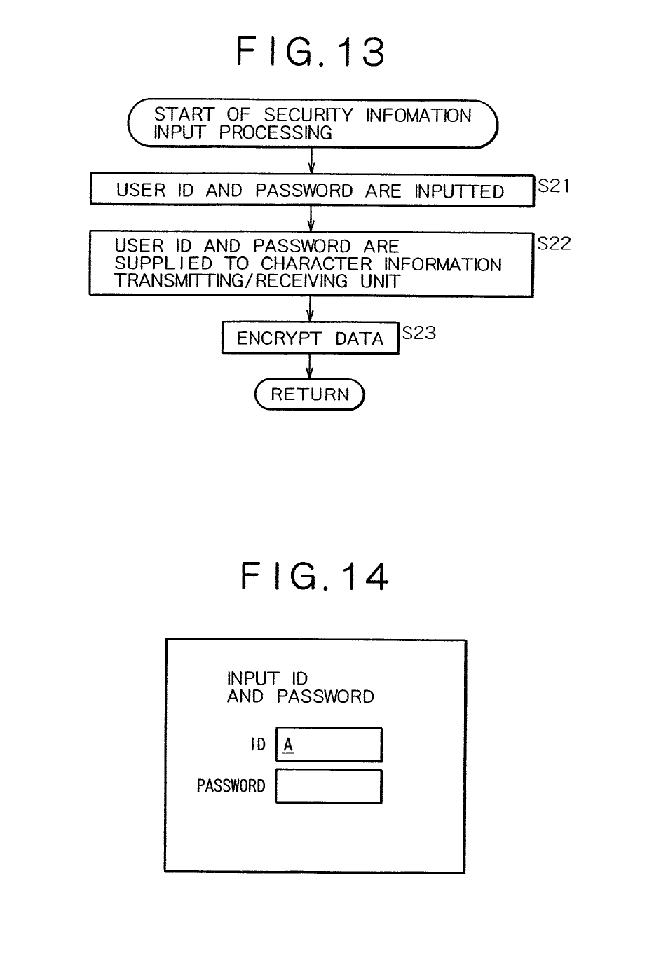

Next, in a step S2, security information input processing is performed. Details of the processing are illustrated in the flowchart shown in FIG. 13.

More specifically, in a step S21, the user operates the input unit 12 (or, the security information input device 14) to input a user id and a password as security information. For example, at this time, it is possible to display an input screen as shown in FIG. 14 on the display unit 13, which prompts a user to input a user id and a password.

In a step S22, the input user id and the password are supplied to the character information transmitting/receiving unit 22 through the game program unit 21.

Next, in a step S23, the character information transmitting/receiving unit 22 encrypts the input user id and the password. After that, the processing ends, and the process proceeds to step S3 shown in FIG. 12.

It is to be noted that the encrypted character information is stored in the character information transmitting/receiving unit 22, and is held there until certain processing has been performed. Among the processing that is to be performed are the following: processing performed when a game ends; processing performed when a power supply of the game machine 1 is turned off; and the like.

In addition to the user id and the password, a user's fingerprint can also be used as security information. In this case, a numerical value corresponding to a fingerprint shape, the user id, and the password are encrypted, and are then stored in the character information transmitting/receiving unit 22.

In the step S3, the character information transmitting/receiving unit 22 of the game machine 1 transmits not only the encrypted security information but also a signal which requests a character list, to the character server 3 through the interface unit 23. The interface unit 34 of the character server 3 receives the signal.

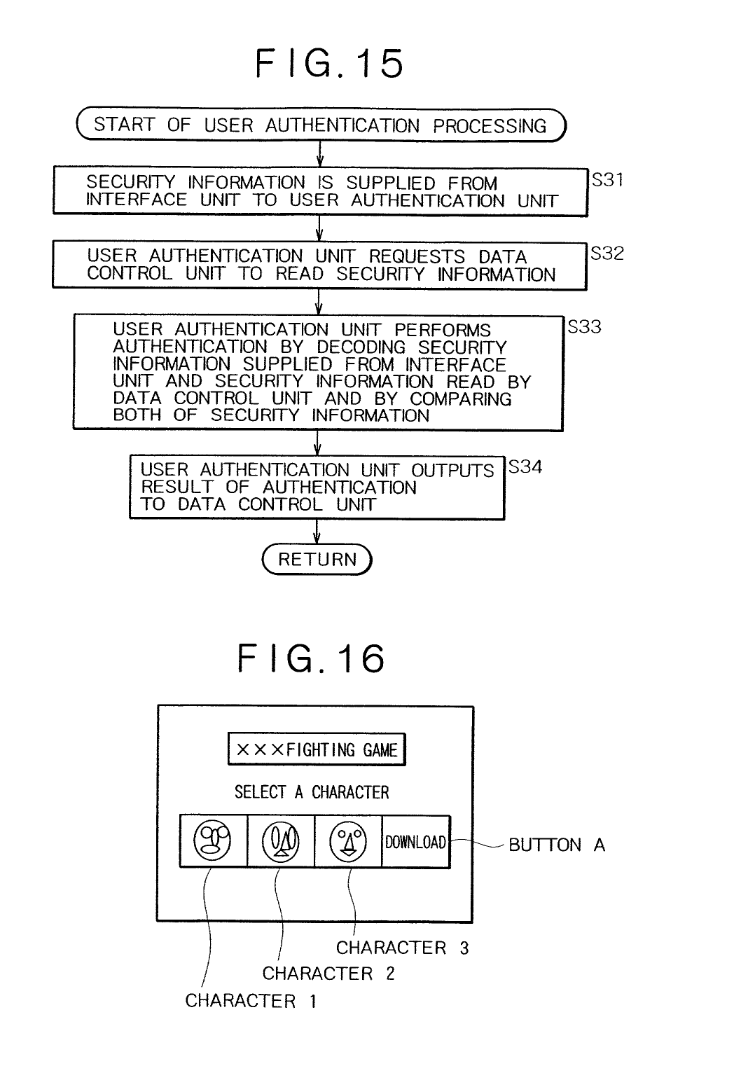

Next, in a step S4, the user authentication unit 33 of the character server 3 performs user authentication processing. Details of the processing are illustrated in the flowchart shown in FIG. 15.

According to the authentication processing, in a step S31 security information received from the game machine 1 is supplied from the interface unit 34 to the user authentication unit 33. After this, in step S32, the user authentication unit 33 requests the data control unit 32 to read “security information” stored in the storage unit 31.

Next, in a step S33, the user authentication unit 33 performs authentication by decoding the security information supplied from the interface unit 34 and the encrypted security information read by the data control unit 32, and comparing both sets of security information. If the data match, that is if the security information supplied from the interface unit 34 (that is, the security information transmitted from the game machine 1) is the same as the “security information” stored in the storage unit 31, the user who has requested the character list by operating the game machine 1 will be authenticated. If the same data are not stored, the user will not be authenticated.

In step S34, the user authentication unit 33 outputs the result of the authentication processing to the data control unit 32. After that, the authentication processing ends and the process proceeds to a step S5 shown in FIG. 12.

In this manner, unauthorized downloading of character information due to falsified authentication data can be avoided.

In the step S5, the data control unit 32 of the character server 3 judges whether or not the user who has requested the character list, has been authenticated according to the results of the authentication processing sent from the user authentication unit 33. If it is judged that the user has been authenticated, the process proceeds to step S6.

In the step S6, the data control unit 32 of the character server 3 transmits a list of characters corresponding to the characters stored in the storage unit 31, which have the user id and the password received in step S3 stored as the character specific information “security information,” to the game machine 1 through the interface unit 34. The interface unit 23 of the game machine 1 receives the list.

Next, in step S7, the game program unit 21 of the game machine 1 obtains the character list, which has been received from the character server 3 by the interface unit 23 through the character information transmitting/receiving unit 22, and then displays the list to the display unit 13. FIG. 16 illustrates an example of a displayed character list. In the case of this example, images corresponding to three characters, character 1, a character 2, and a characters 3, are shown.

Next, in a step S8, the user operates the input unit 12 of the game machine 1 to select a desired character, and issues an instruction causing that character's information to be downloaded. In the example shown in FIG. 16, the desired character is selected and a button A is operated to download the character's information.

In step S9, the game program unit 21 of the game machine 1 supplies the id of the selected character and the item id of the required character specific information to the character information transmitting/receiving unit 22. The character information transmitting/receiving unit 22 transmits the character id and the item id together with the security information encrypted in step S2 to the character server 3 through the interface unit 23, and the interface unit 34 of the character server 3 receives the information.

Next, in a step S10, user authentication processing is performed by the character server 3. However, because the processing is similar to that of the step S4, further explanation of the authentication processing is omitted here.

In a step S11, the data control unit 32 of the character server 3 judges whether or not the user has been authenticated based on the result of authentication in the step S10. If it is judged that the user has been authenticated, the process proceeds to step S12 where information corresponding to the character id and the item id of the character specific information is transmitted to the game machine 1 through the interface unit 34 and is received by the interface unit 23 of the game machine 1. In other words, the character information is downloaded into the game machine 1. Then, the processing ends.

If it is judged in the step S5 or the step S11 that the user has not been authenticated, the process proceeds to step S13 where the user authentication unit 33 of the character server 3 transmits a signal indicating the judgment result to the game machine 1 through the interface unit 34. The interface unit 23 of the game machine 1 receives the signal.

Next, in a step S14, the game program unit 21 of the game machine 1 obtains the signal that has been received by the interface unit 23 through the character information transmitting/receiving unit 22. This indicates that the user has not been authenticated. After that, the game program unit 21 displays an indication that the authentication failed in the display unit 13, and prompts the user to input a user id and a password again.

In a step S15, a game program unit 21 of the game machine 1 increments a value of the counter i by 1. The counter i counts the number of times the user has not been authenticated.

In a step S16, the game program unit 21 of the game machine 1 judges whether or not the value of the counter i is greater than or equal to a given value N. If it is judged that the value is less than the given value N, the process returns to the step S2, and continues processing. On the other hand, if it is judged that the value i is greater than or equal to the given value N, the processing ends. Thus, if the user id and password are not authenticated N times or more continuously, the character information is not downloaded.

As indicated in FIG. 1, character information may be downloaded to a number of different game machines, 1-1, 1-2, 1-3. Each game machine may have different performance characteristics. For example, if a high-performance arcade game machine 1-2 is compared with a portable game machine 1-3 of which performance is low, the number of polygons, quality of texture, a parameter of quality of material, and the like, which express a character and an item, may be different.

Because of this, after the character information is downloaded, the character information transmitting/receiving unit 22 of the game machine 1 converts the character information into data that suits the performance characteristics of the game machine 1. In this connection, the “three-dimensional information” of the character information downloaded from the character server 3 supports high-quality image data.

For example, in the case of a 3D game in which a three-dimensional object is expressed by a polygon model, if performance of the game machine 1 is low, the number of polygons relating to characters and items is decreased. It is to be noted that a method describing how to decrease the number of polygons effectively is disclosed in Japanese Patent Application No. Hei 11-145471, the teaching of which is incorporated herein by reference.

In addition, if a VRAM area in the game machine 1 is small, texture is reduced. Technology for lowering image resolution as an MIP mapping method is disclosed in “Pyramidal Prametrics” written by Lance Williams (SIGGRAPH 1983 Proceedings), the teaching of which is incorporated herein by reference.

In addition, a parameter of quality of material is changed corresponding to performance of the game machine 1.

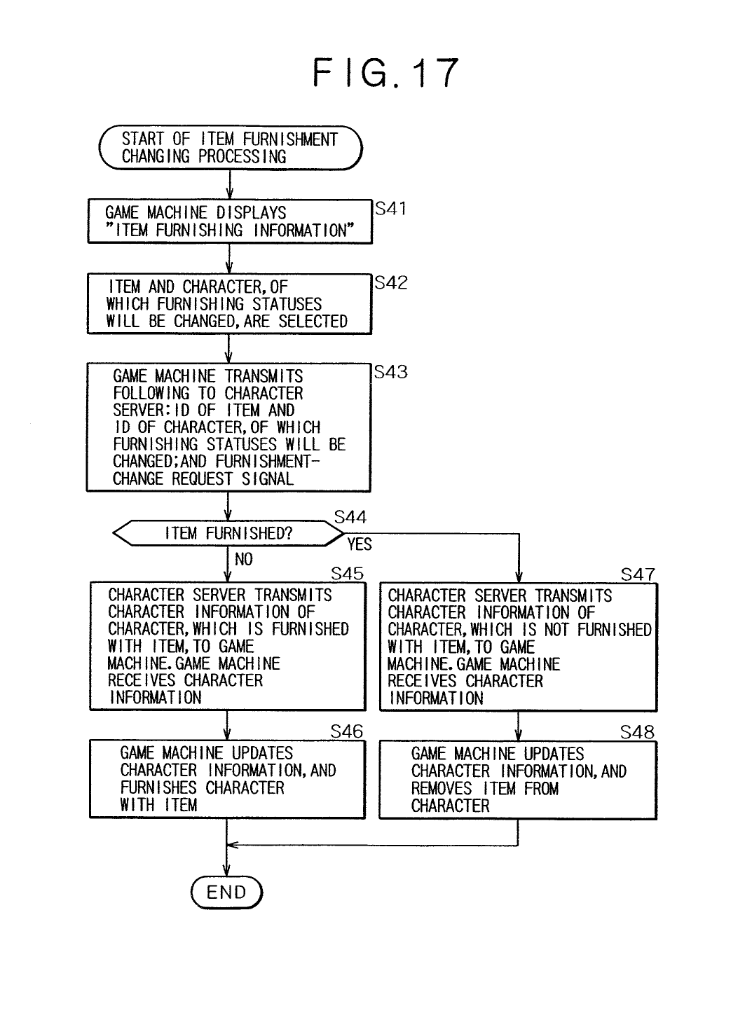

Next, character editing processing will be described with reference to a flowchart shown in FIG. 17. The processing described in FIG. 17 is performed on the assumption that the user has already been authenticated.

In step S41, the game program unit 21 of the game machine 1 displays either the character information downloaded as described above, or an “item furnishing information” of the preset character information (for example, FIG. 7), on the display unit 13. As a result, furnishing information is displayed together with, for example, each item.

Next, in a step S42, the user operates the input unit 12 to select an item and a character, of which furnishing statuses are required to be changed. After that, in step S43, the game program unit 21 outputs the id of the selected item and the id of the selected character to the character information transmitting/receiving unit 22.

The character information transmitting/receiving unit 22 then transmits the selected item id and the selected character id, together with a furnishment-change request signal, to the character server 3 through the interface unit 23, where they are received by the character server 3.

In step S44, the data control unit 32 of the character server 3 references “item furnishing information” of the character information corresponding to the received character id, which is stored in the storage unit 31 that stores the character information of authenticated users. Then, the data control unit 32 checks the furnishing status of an item identified by the received item id, and judges whether or not the item is furnished. If it is judged that the item is not furnished, the process proceeds to a step S45.

In step S45, the data control unit 32 of the character server 3 transmits character information of a character, which is furnished with the item, to the game machine 1 through the interface unit 34, and the game machine 1 receives the character information.

In step S46, the game program unit 21 of the game machine 1 obtains the character information received by the interface unit 23 through the character information transmitting/receiving unit 22. Then, using the character information, the game program unit 21 updates character information that it now holds. This permits the character, which is furnished with the selected items, to appear in a game.

On the other hand, if in step S44, if it is judged that the item is furnished, the process proceeds to step S47. There, the data control unit 32 of the character server 3 transmits character information of a character, which is not furnished with the item, to the game machine 1 through the interface unit 34. The game machine 1 receives the character information.

In a step S48, the game program unit 21 of the game machine 1 obtains the character information received by the interface unit 23 through the character information transmitting/receiving unit 22. Then, using the character information, the game program unit 21 updates character information that it now holds. This permits the character, which is not furnished with the selected items, to appear in a game.

After the processing of the step S46 or S48 is performed, the process ends.

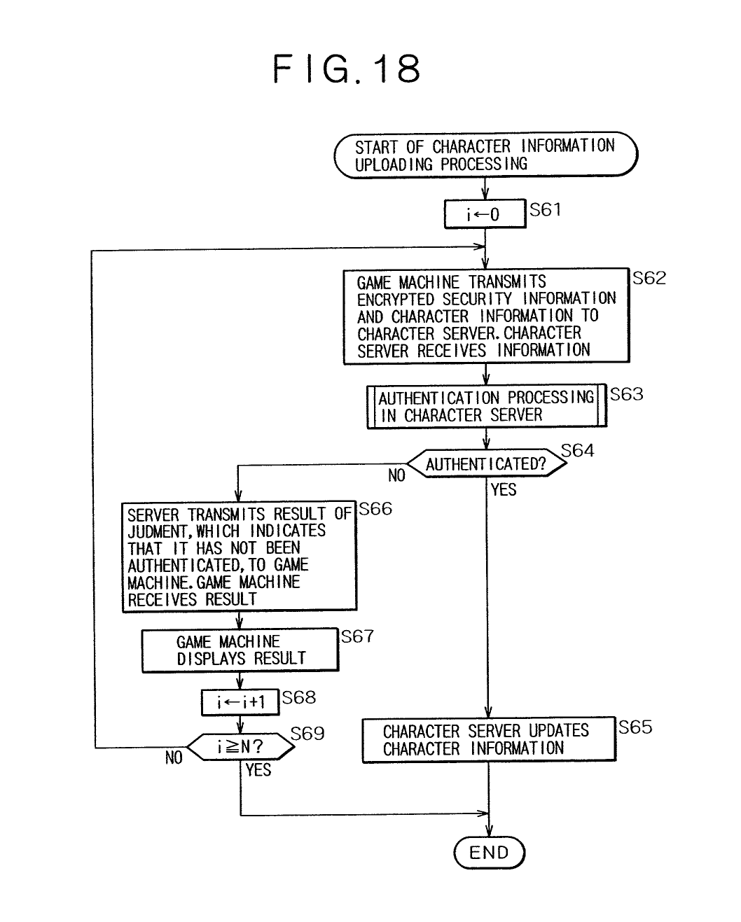

Next, processing procedures used when character information is uploaded will be described with reference to a flowchart shown in FIG. 18. In this case, it is assumed that encrypted security information has been stored in the character information transmitting/receiving unit 22.

In step S61, a game program unit 21 of the game machine 1 initializes a counter i so that the counter i has value 0. Next, in a step S62, the character information transmitting/receiving unit 22 transmits the character information (for example, a changed item id and its parameter) together with the encrypted security information to the character server 3 through the interface unit 23. The character server 3 receives the character information.

When editing a character, the user can make the character from scratch by himself/herself. In this case, for example, Lightwave3DTM produced by Newtek in the United States, 3D Studio Max™ produced by DiscreetLogic, and the like, can be used. Additionally, a product like Teddy can also be used to make a 3D model more easily. It is to be noted that Teddy is described in “Teddy: A Sketching Interface for 3D Freeform Design”(SIGGRAPH99 Conference Proceedings pp409-416) by Takeo Igarashi, the teaching of which is incorporated herein by reference.

Japanese Patent Application No. Hei 10-272733, assigned to the present applicant, describes a method for obtaining three-dimensional shape information and texture information on an individual body using a three-dimensional digitizer, and for making a character according to such information. This method permits the generation of a character having characteristics of an individual body.

Moreover, it is possible to tailor a character downloaded from the character server 3, and a character provided beforehand in a game. For example, it is possible to edit a character by selecting parts, such as eyes, a nose, a mouth, and a hairstyle, from a given parts list, and to edit the selected parts as well as various other aspects of the character such as by adjusting lengths of the character's hands and feet, and its stature.

In step S63, the user authentication unit 33 of the character server 3 performs authentication processing. Because identity of the user must be authenticated, falsification of uploaded character information can be avoided. Since the authentication processing is the same as that in the step S4 shown in FIG. 12, a detailed explanation is omitted here.

In step S64, the data control unit 32 of the character server 3 judges whether or not the user who sent the character information has been authenticated according to the result of the authentication signal sent from the user authentication unit 33. If it is judged that the user has been authenticated, the process proceeds to step S65.

In step S65, the data control unit 32 updates character specific information which is stored in the storage unit 31 that stores “security information,” including an authenticated user id and password, according to the information received by the step S62.

If it is judged in step S64 that the user has not been authenticated, the process proceeds to step S66. The processing from the step S66 to the step S69 is the same as that from step S13 to step S16 shown in FIG. 12, therefore, a detailed explanation of steps S66 to S69 is omitted.

As described above, the character information is uploaded.

Although it was not described above, in order to update the utilization time included in the “history information” stored in the storage unit 31 of the character server 3, the game program unit 21 of the game machine 1 records a time period over which the character is utilized. The utilization time of the character is transmitted to the character server 3 with the recorded time.

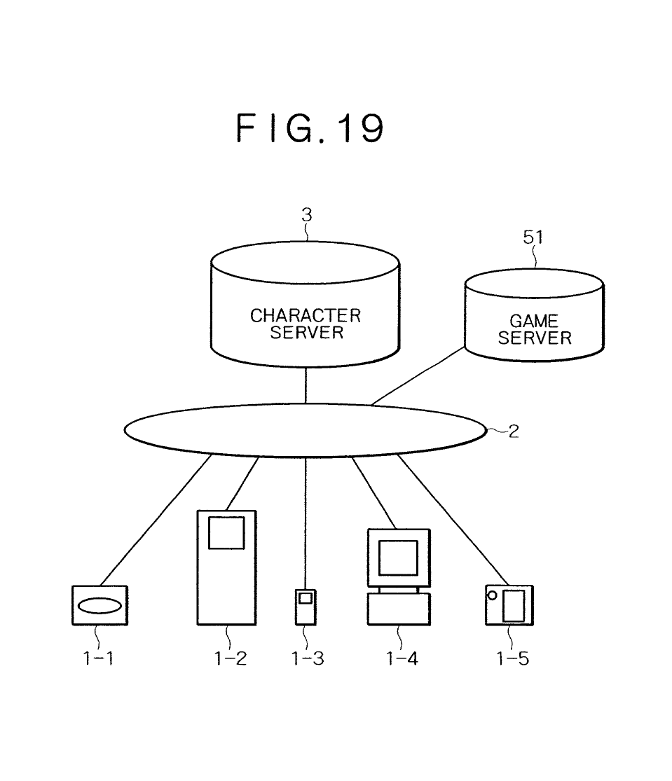

Furthermore, the embodiments described above are based on the assumption that a game to be executed in the game machine 1 is a game recorded in the main body 11 beforehand, or a game recorded on a recording medium. However, as shown in FIG. 19, it is also possible to configure the game machine 1 so that the game machine 1 can obtain a program for a desired game by communicating with the game server 51 which stores programs for various games.

Although the processing described above can be realized by means of hardware, it is also possible to realize the processing by means of software. When realizing the processing by means of software, the above-mentioned character server 3 is functionally realized by installing a program, which configures software, in a computer, and by executing the program in the computer.

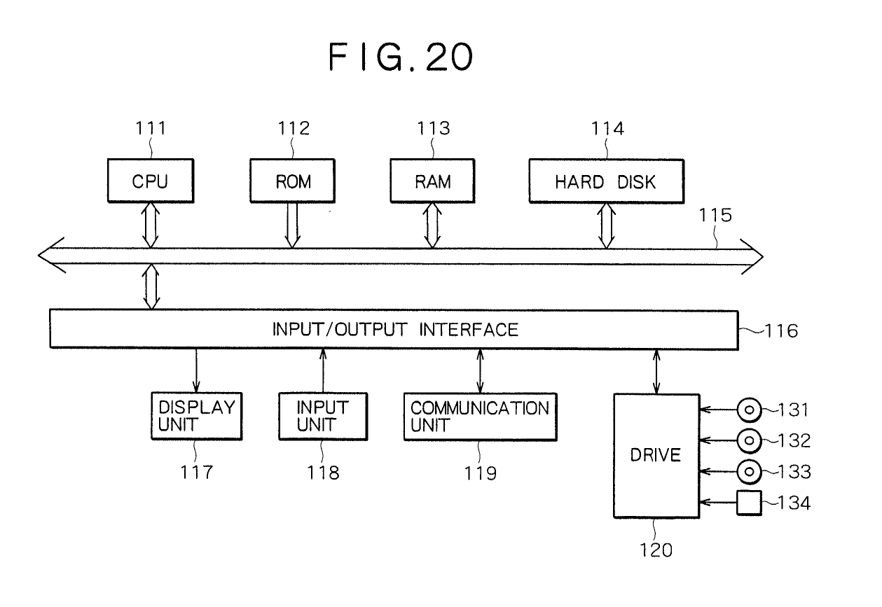

FIG. 20 is a block diagram illustrating a configuration of an embodiment of a computer 101, which functions as the character server 3 as described above. An input/output interface 116 is connected to a CPU (Central Processing Unit) 111 via a bus 115.

When an instruction is input by a user from an input unit 118 comprising a keyboard, a mouse, and the like, through an input/output interface 116, the CPU 111 loads a program into a RAM 113 (Random Access Memory) to execute the program. In this case, the program is stored in, for example, a ROM (Read Only memory) 112, a hard disk 114, or a recording medium (such as a magnetic disk 131, an optical disk 132, a magneto-optical disk 133, or a semiconductor memory 134) that is attached to a drive 120. As a result, the various kinds of processing described above (for example, processing illustrated in flowcharts in FIGS. 12, 15, 17, and 18) is performed. In addition, the CPU 111 outputs a result of the processing to a display unit 117, which comprises an LCD (Liquid Crystal Display), or the like, through, for example, the input/output interface 116 as necessary. In this connection, the program can be provided in the following methods: storing the program in the hard disk 114 or the ROM 112 beforehand, and provide the user with the program together with the computer 101 in an integrated manner; providing the program as a package medium such as the magnetic disk 131, the optical disk 132, the magneto-optical disk 133, and the semiconductor memory 134; and providing the hard disk 114 with the program from a satellite, a network, or the like through a communication unit 119.

It should be noted that, in this specification, a step for describing a program provided by a recording medium includes not only processing performed as a series of steps according to a described sequence, but also processing performed in parallel or individually even if the processing is not necessarily performed in the same time sequence.

Moreover, in this specification, the system means a whole set of devices comprising a plurality of devices.

According to the information processing apparatus, the information processing method, and the program in the recording medium, of the present invention, information related to a character, which can appear in a plurality of games in a terminal, is stored. In addition, in response to a request from the terminal, the information related to the character is transmitted to the terminal. Therefore, the given character can be used in a plurality of games in the terminal.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An information processing apparatus connected to a terminal, which executes a program for a plurality of games, through a network, comprising:
holding means for holding information on a character that can appear in the plurality of games in said terminal; and
transmitting means for transmitting said information on the character to said terminal in response to a request from said terminal.

2. An information processing apparatus according to claim 1, wherein said information on the character is information related to how the character appears, information on attributes of the character, or information indicating items related to the character.

3. An information processing apparatus according to claim 2, wherein said information on appearance is information indicating a shape, quality of material, or texture, concerning an image of the character.

4. An information processing apparatus according to claim 2, wherein said information on attributes is information indicating: a level of power at which the character can perform given processing in the game; a characteristic of the character; or an operation that can be carried out by the character.

5. An information processing apparatus according to claim 2, wherein said item includes music or video.

6. An information processing apparatus according to claim 1, wherein said terminal is one of: an arcade game machine, a home game machine, or a portable game machine.

7. An information processing apparatus connected to a terminal, which executes a program for a plurality of games, through a network, comprising:
holding means for holding information on a character that can appear in the plurality of games in said terminal;
transmitting means for transmitting said information on the character to said terminal in response to a request from said terminal;
receiving means for receiving said information on the character transmitted from said terminal; and
updating means for updating said information on the character, which is held in said holding means, according to said information on the character received by said receiving means.

8. An information processing apparatus according to claim 7, wherein said information related on the character is information related to how the character appears, information on attributes of the character, or information indicating items associated with the character.

9. An information processing apparatus according to claim 8, wherein said information on appearance is information indicating a shape, quality of material, or texture, concerning an image of the character.

10. An information processing apparatus according to claim 8, wherein said information on attributes is information indicating: a level of power at which the character can perform given processing in the game; a characteristic of the character; or an operation that can be carried out by the character.

11. An information processing apparatus according to claim 8, wherein said item includes music or video.

12. An information processing apparatus according to claim 7, wherein said terminal is one of: an arcade game machine, a home game machine, or a portable game machine.

13. An information processing apparatus connected to a terminal, which executes a program for a plurality of games, through a network, comprising:
holding means for holding information on a character that can appear in the plurality of games in said terminal;
transmitting means for transmitting said information on the character to said terminal in response to a request from said terminal; and
obtaining means for obtaining utilization time of the character, which has been used in the game in said terminal, from said terminal;
wherein said holding means holds said utilization time, which has been obtained by said obtaining means, for each game.

14. An information processing apparatus according to claim 13, wherein said information on the character is information related to how the character appears, information on attributes of the character, or information indicating items associated with the character.

15. An information processing apparatus according to claim 14, wherein said information on appearance is information indicating a shape, quality of material, or texture, concerning an image of the character.

16. An information processing apparatus according to claim 14, wherein said information on attributes is information indicating: a level of power at which the character can perform given processing in the game; a characteristic of the character; or an operation that can be carried out by the character.

17. An information processing apparatus according to claim 14, wherein said item includes music or video.

18. An information processing apparatus according to claim 13, wherein said terminal is one of: an arcade game machine, a home game machine, or a portable game machine.

19. An information processing method of an information processing apparatus connected to a terminal, which executes a program for a plurality of games, through a network, said information processing method comprising:
a holding step for holding information on a character that can appear in the plurality of games in said terminal; and
a transmitting step for transmitting said information on the character to said terminal in response to a request from said terminal.

20. An information processing method according to claim 19, wherein said information on the character is information related to how the character appears, information on attributes of the character, or information indicating items associated with the character.

21. An information processing method according to claim 20, wherein said information on appearance is information indicating a shape, quality of material, or texture, concerning an image of the character.

22. An information processing method according to claim 20, wherein said information on attributes is information indicating: a level of power at which the character can perform given processing in the game; a characteristic of the character; or an operation that can be carried out by the character.

23. An information processing method according to claim 20, wherein said item includes music or video.

24. An information processing method according to claim 19, wherein said terminal is one of: an arcade game machine, a home game machine, or a portable game machine.

25. An information processing method of an information processing apparatus connected to a terminal, which executes a program for a plurality of games, through a network, said information processing method comprising:
a holding step for holding information on a character that can appear in the plurality of games in said terminal;
a transmitting step for transmitting said information on the character to said terminal in response to a request from said terminal;
a receiving step for receiving said information on the character transmitted from said terminal; and
an updating step for updating said held information on the character, according to said information on the character received in said receiving step.

26. An information processing method according to claim 25, wherein said information on the character is information on appearance of the character, information on attributes, or information indicating items.

27. An information processing method according to claim 26, wherein said information on appearance is information indicating a shape, quality of material, or texture, concerning a character image.

28. An information processing method according to claim 26, wherein said information on attributes is information indicating: a level of power at which the character can perform given processing in the game; characteristics of the character; or operation that can be carried out by the character.

29. An information processing method according to claim 26, wherein said item includes music or video.

30. An information processing method according to claim 25, wherein said terminal is an arcade game machine, a home game machine, or a portable game machine.

31. An information processing method of an information processing apparatus connected to a terminal, which executes a program for a plurality of games, through a network, said information processing method comprising:
a holding step for holding information on a character that can appear in the plurality of games in said terminal;
a transmitting step for transmitting said information on the character to said terminal in response to a request from said terminal; and
an obtaining step for obtaining utilization time of the character, which has been used in the game in said terminal, from said terminal; and
a utilization time holding step for holding said utilization time, which has been obtained in said obtaining step, for each game.

32. An information processing method according to claim 31, wherein said information on the character is information related to how the character appears, information on attributes of the character, or information indicating items related to the character.

33. An information processing method according to claim 32, wherein said information on appearance is information indicating a shape, quality of material, or texture, concerning an image of the character.

34. An information processing method according to claim 32, wherein said information on attributes is information indicating: a level of power at which the character can perform given processing in the game; a characteristic of the character; or an operation that can be carried out by the character.

35. An information processing method according to claim 32, wherein said item includes music or video.

36. An information processing method according to claim 31, wherein said terminal is one of: an arcade game machine, a home game machine, or a portable game machine.

37. A recording medium, on which a computer-readable program is recorded, wherein said computer-readable program is a program of an information processing apparatus connected to a terminal, which executes a program for a plurality of games, through a network,
said computer-readable program comprising:
a holding step for holding information on a character that can appear in the plurality of games in said terminal; and
a transmitting step for transmitting said information on the character to said terminal in response to a request from said terminal.

38. A recording medium according to claim 37, wherein said information on the character is information related to how the character appears, information on attributes of the character, or information indicating items associated with the character.

39. A recording medium according to claim 38, wherein said information on appearance is information indicating a shape, quality of material, or texture, concerning an image of the character.

40. A recording medium according to claim 38, wherein said information on attributes is information indicating: a level of power at which the character can perform given processing in the game; a characteristic of the character; or an operation that can be carried out by the character.

41. A recording medium according to claim 38, wherein said item includes music or video.

42. A recording medium according to claim 37, wherein said terminal is one of: an arcade game machine, a home game machine, or a portable game machine.

43. A recording medium, on which a computer-readable program is recorded, wherein said computer-readable program is a program of an information processing apparatus connected to a terminal, which executes a program for a plurality of games, through a network,
said computer-readable program comprising:
a holding step for holding information on a character that can appear in the plurality of games in said terminal;
a transmitting step for transmitting said information on the character to said terminal in response to a request from said terminal;
a receiving step for receiving said information on the character transmitted from said terminal; and
an updating step for updating said held information on the character, according to said information on the character received in said receiving step.

44. A recording medium according to claim 43, wherein said information on the character is information on how the character appears, information on attributes of the character, or information indicating items associated with the character.

45. A recording medium according to claim 44, wherein said information on appearance is information indicating a shape, quality of material, or texture, concerning an image of the character.

46. A recording medium according to claim 44, wherein said information on attributes is information indicating: a level of power at which the character can perform given processing in the game; a characteristic of the character; or an operation that can be carried out by the character.

47. A recording medium according to claim 44, wherein said item includes music or video.

48. A recording medium according to claim 43, wherein said terminal is one of: an arcade game machine, a home game machine, or a portable game machine.

49. A recording medium, on which a computer-readable program is recorded, wherein said computer-readable program is a program of an information processing apparatus connected to a terminal, which executes a program for a plurality of games, through a network,
said computer-readable program comprising:
a holding step for holding information on a character that can appear in the plurality of games in said terminal;
a transmitting step for transmitting said information on the character to said terminal in response to a request from said terminal;
an obtaining step for obtaining utilization time of the character, which has been used in the game in said terminal, from said terminal; and
a utilization time holding step for holding said utilization time, which has been obtained in said obtaining step, for each game.

50. A recording medium according to claim 49, wherein said information on the character is information related to how the character appears, information on attributes of the character, or information indicating items associated with the appearance of the character.

51. A recording medium according to claim 50, wherein said information on appearance is information indicating a shape, quality of material, or texture, concerning an image of the character.

52. A recording medium according to claim 50, wherein said information on attributes is information indicating: a level of power at which the character can perform given processing in the game; a characteristic of the character; or an operation that can be carried out by the character.

53. A recording medium according to claim 50, wherein said item includes music or video.

54. A recording medium according to claim 49, wherein said terminal is one of:
an arcade game machine, a home game machine, or a portable game machine.
